(19) United States
(12) Patent Application Publication
(10) Pub. No.: US 2006/0171853 A1
(43) Pub. Date: Aug. 3, 2006

(54) Tips for pipetting devices or dispensing devices

(76) Inventors: Thomas Moore, Jena (DE); Peter Zimmermann, Kahla (DE); Torsten Rausch, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/344,685

(22) Filed: Jan. 31, 2006

(30) Foreign Application Priority Data
Jan. 31, 2005 (DE) 20 2005 001 613.6

(51) Int. Cl. B01L 3/02

(52) U.S. Cl. 422/100

(57) ABSTRACT

A tip comprises an elongated, axially symmetric hollow tip body with an outlet opening for dispensing precise amounts of liquid and a receiving opening with a diameter that is greater than the outlet and a tubular inlay which is inserted into the hollow space of the tip body.

### CROSS-REFERENCE TO RELATED APPLICATIONS

This application claims priority of German Application No. 20 2005 001 613.6, filed Jan. 31, 2005, the complete disclosure of which is hereby incorporated by reference.

### BACKGROUND OF THE INVENTION

a) Field of the Invention

Liquid handling devices such as pipetting devices and dispensing devices are used in laboratories for handling liquids and are distinguished from one another substantially by the way in which the liquid to be transferred is received and dispensed.

b) Description of the Related Art

Pipetting devices take the liquid from a source vessel by means of pipetting tips, as they are called, and dispense them into a target vessel. Dispensing devices transport the liquid from a supply vessel to a target vessel by means of nozzles.

In the following description, the pipetting tips and the nozzles are designated as a unit as tips. These tips have a dispensing opening by which the liquid is dispensed and a receiving opening by which the tips are indirectly or directly connected to (received by) a pipetting device or dispensing device.

Pipetting tips made from polypropylene are the most commonly used disposable tips for pipetting devices. Because they are manufacturing by injection molding, these pipetting tips vary greatly in accuracy with respect to dimensions and shape. Variations in quality of the mold release outlets, differences in the coaxiality of the cavity and mandrel, and formation of films (flash) at the injection molded article in the closing area of the die lead to broad variations in the transferred volumes which cannot be tolerated particularly for very small volumes in the nanoliter range.

Apart from the geometric parameters, the wetting characteristics (contact angle, surface tension) of the surface are important in tips for pipetting devices because the pipetting tip is immersed in the source vessel in order to receive liquid.

Often, the target vessel already contains another liquid in which the liquid to be transferred is dispensed. Immersion in a liquid is in itself sufficient to transfer a small amount of liquid because of the consequent wetting of the surface of the tip. The smaller the amount to be transferred, the higher the proportion of transferred liquid caused by wetting. In view of the fact that the amounts transferred by wetting cannot be reproduced with accuracy, they also contribute to variations in the volume of the amounts of liquid transferred by different tips.

The problems mentioned above can be substantially mitigated through the use of highly precise, well-polished tips made of ceramic.

Tips made from other very hard materials such as tungsten, titanium, stainless steel or drawn glass capillaries are also known.

Since the advantage of a disposable article is naturally lost when using tips of the kind mentioned above, another very important property is good washability so that the surface and the geometry also become important when viewed from this perspective.

The commonest pipetting devices are based on the principle of air-displacing piston pipettes combined with pipette tips. In this simple technique, there is a relationship between the smallest volumes that can be dispensed and the residual volume that is displaced by liquid in the pipette between the liquid column and the piston (dead volume). With large dead volume, very small movements of the piston do not cause any significant pressure increases, so that the liquid menisci of the liquid column merely deform slightly but no liquid is transported. When the filled pipette tip is immersed in liquid, only the inner meniscus is still effective. With an unfavorable ratio of dispensing volume to dead volume (the dispensing volume should be very small in relation to the dead volume), this leads to fluctuations in the dispensing volume of a tip over several successive dispensing processes. Because of this effect, it is attempted in principle to keep the dead volume in the pipette very small.

It is precisely in the case of ceramic tips, which in other respects best meet the requirements for a tip provided for pipetting in the nanoliter range, that it is possible to reduce this dead volume only to a limited extent through the technique used to manufacture it.

Ceramic tips with dispensing openings having a diameter of 50 μm to 250 μm are produced by means of injection molding methods or special pressing methods. There are only a few firms that possess this know-how. In both techniques, the inner contour of the tip is produced by a conical body (mandrel) which must be withdrawn from the blank in the direction of the receiving opening at a determined point during the production of the tip. In this connection, the cone angle may change along the length. As the length of the tip delimited by the dispensing opening and the receiving opening increases, the diameter in the area of the receiving opening must also increase so that the mandrel remains mechanically stable. The inner shape of most commercially available ceramic tips is determined by a first area with a large cone angle and by a second area with a hardly perceptible cone angle. This results in tips which, at a length of 10 mm to 20 mm and an outlet opening of 200 μm, for example, have a receiving opening diameter of about 1 mm. This makes for a large dead volume in the tips so that, as was already mentioned, a precise transfer of liquid of 20 nl to 100 nl, for example, along with an only slight breadth of variation over a plurality of tips is impossible.

In contrast to the tips of pipetting devices in which the liquid to be transferred is received and dispensed via the dispensing openings of the tips, the liquid to be dispensed in dispensing devices is received from a supply vessel via the receiving openings of the tips and is dispensed through the latter from the dispensing openings.

A number of devices of the type mentioned above work with overpressure and a fast valve. Devices of this kind are also called free-jet dispensers and dispense the quantities of liquid without contacting the target. They are very fast and have a number of advantages, e.g., that the liquid reservoir can be kept sealed, dark, and cool.

Dispensing devices have also been developed for dispensing very small quantities in order to economize on the costs of reagents or to dispense very small droplets in close succession. Good results are also obtained in this case with ceramic tips, but a problem is also encountered in that the inner diameter of the tip is larger along its length toward the receiving opening because of the technique employed. Therefore, the fluidic resistance, which needs a small diameter along a determined length, cannot be increased sufficiently. This would lead to a reduction of the dispensing volume over the same valve opening time. Accordingly, this goal must be achieved through different steps, e.g., by reducing the pressure, reducing the outlet opening, or reducing the switching time of the valve. However, outlet openings that are too small decrease robustness, insufficiently high pressure on the reservoir diminishes the reproducibility of the dispensing volumes, and switching times for electromechanical valves can be shortened only to a limited extent.

Ceramic tips known from the prior art are described, for example, in WO 97/46319 and WO 00/01798. They comprise a lower conical part with an outlet opening diameter of approximately 50 μm and an upper, substantially cylindrical part whose inner diameter is appreciably greater than the diameter of the outlet opening. It is assumed in the present application that the tips described herein have precisely the same disadvantages as the ceramic tips mentioned above.

### OBJECT AND SUMMARY OF THE INVENTION

It is the primary object of the invention to provide a tip which makes it possible to dispense liquid in a precisely reproducible manner in the nanoliter range in connection with pipetting devices as well as with dispensing devices.

According to the invention, this object is met for a tip comprising an elongated, axially symmetric hollow tip body with an outlet opening for dispensing precise amounts of liquid and a receiving opening with a diameter that is greater then the outlet opening and a tubular inlay which is inserted into the hollow space of the body tip.

The essence of the invention resides in the idea that the volume of the interior of the tip, which is larger than the product of the outlet opening and length due to manufacture, is reduced by means of an insert (inlay).

Accordingly, the dead volume is reduced for tips that are provided for a pipetting device. In a tip for a dispensing device, a higher fluidic resistance and an altered fluidic inductance are brought about. The precision and reproducibility with which the liquid is dispensed is increased in both cases, particularly with volumes in the nanoliter range and picoliter range.

The inlay of a tip for dispensing devices advantageously has an inner diameter that is equal to the outlet opening in order to prevent fluidic discontinuity.

The inner diameter of the inlay for a tip for pipetting devices is advantageously as small as possible. In contrast to the tip for a dispensing device, where the liquid must be pressed through the inlay, the through-hole in the inlay of a tip for a pipetting device need only be sufficiently large for gas exchange.

The end of the inlay facing the outlet opening should be at a distance from the outlet opening such that the liquid column lies just below the inlay when the tip is filled to the maximum.

For a tip that is provided for a dispenser, the end of the inlay facing the outlet opening should lie as close to the outlet opening as is possible based on the technique employed without limiting the mechanical precision of the tip around the outlet opening.

For both applications, the end of the inlay facing the receiving opening is advantageously in the plane of the receiving opening insofar as the inlay does not also serve as an extension or lengthening of the overall arrangement.

The invention will be described more fully in the following with reference to two embodiment examples shown in the drawings.

### BRIEF DESCRIPTION OF THE DRAWINGS

In the drawings:

FIG. 1 shows a tip for a pipetting device in section; and

FIG. 2 shows a tip for a dispensing device in section.

### DESCRIPTION OF THE PREFERRED EMBODIMENTS

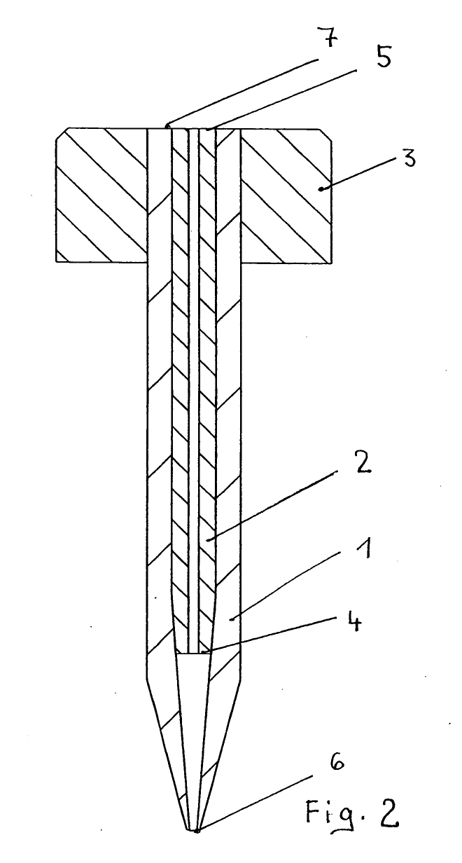

The tip shown in FIG. 2, which is particularly suitable for a dispensing device, comprises a ceramic tip body 1 having an inlay 2 that is not substantially shorter than the tip body 1. The distance between the outlet opening 6 of the tip body 1 and the end 4 of the inlay 2 facing the outlet opening 6 is as small as possible and is determined by the technology employed for manufacture and assembly. With respect to the receiving opening 7, the inlay 2 terminates in the plane of the receiving opening 7. The total length of the tip is determined by the length of the tip body 1. The holder part 3 surrounding the tip body 1 serves only for attaching the tip to a dispensing device. The inlay 2 can be a tubular body that is manufactured in any manner desired, e.g., it can be made of a metal such as stainless steel, titanium, or as a hollow tungsten needle, of plastic such as a PEEK tube or polyimide tube, or of glass. In selecting the material for an inlay 2, it must be ensured that the liquid in the tips for a pipetting device does not come into contact with the inlay, whereas in tips for a dispensing device the liquid must pass through the inlay.

It can easily be seen from this simple construction that the throughput volume of the tip is substantially determined by the inner diameter of the inlay 2 and—only near the outlet opening 6—by the inner diameter of the tip body 1. Ideally, the inner diameter of the inlay 2 is equal to the diameter of the outlet opening 6.

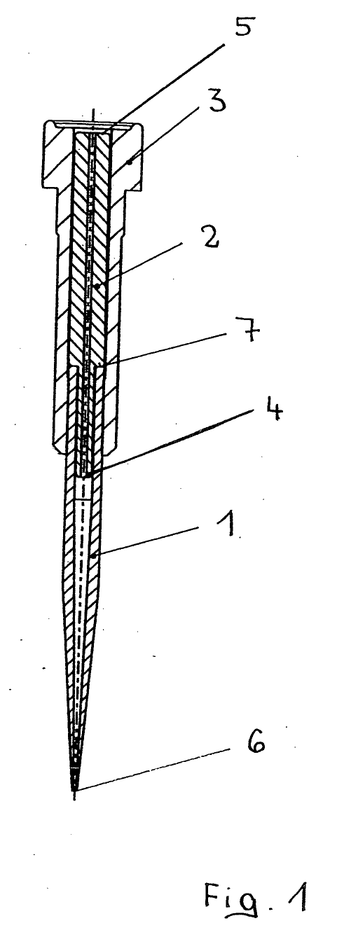

The tip shown in FIG. 1 is a particularly advantageous construction for a tip for use in a pipetting device. Since tips of this type must, as a rule, be longer so that they can also be inserted to a sufficient depth into high vessels for receiving liquid, the tip body 1, which is likewise made of ceramic in this instance, can advantageously be lengthened by means of an inlay 2. This means that the inlay 2 serves not only to reduce the throughput volume of the tip (in this case for gas exchange) but also to lengthen the tip. Accordingly, the tip body 1 which is subject to strict requirements can be made shorter and can therefore be manufactured in a simpler manner. The holder part 3 surrounding the inlay 2 and the tip 1 imparts stability to the construction and is used for fastening the tip to the pipetting device.

When the inlay 2 is fitted into the tip body 1, the end 4 of the inlay 2 facing the outlet opening 6 is at a distance from the outlet opening 6 such that the maximum volume of liquid received through the outlet opening 6 does not come into contact with the inlay 2. The dead volume is extensively reduced to the inner volume of the inlay 2 corresponding to the product of the length of the inlay and the inner diameter of the inlay 2.

While the foregoing description and drawings represent the present invention, it will be obvious to those skilled in the art that various changes may be made therein without departing from the true spirit and scope of the present invention.

What is claimed is:

1. A tip comprising:
an elongated, axially symmetric hollow tip body with an outlet opening for dispensing precise amounts of liquid and a receiving opening with a diameter that is greater than the outlet opening; and
a tubular inlay being inserted into the hollow space of the tip body.

2. The tip according to claim 1, wherein the tip is connected to a pipetting device and the inlay determines the dead volume above the amount of liquid in the tip.

3. The tip according to claim 1, wherein the tip is connected to a dispensing device and the inlay determines the fluidic resistance inside the tip.

4. The tip according to claim 3, wherein the inner diameter of the inlay corresponds to the diameter of the outlet opening.

5. The tip according to claim 4, wherein the tip body is made of ceramic.

6. The tip according to claim 2, wherein the inlay on the side of the receiving opening projects beyond the latter and lengthens the tip body.
